(19) United States
(12) Patent Application Publication
(10) Pub. No.: US 2016/0350847 A1
(43) Pub. Date: Dec. 1, 2016

(54) METHOD AND PROGRAM FOR CALCULATING ECONOMIC BENEFITS OF SOCIAL PROGRAMS AND SERVICES

(71) Applicant: Philadelphia Bar Foundation, Philadelphia, PA (US)

(72) Inventor: Baruch Kintisch, Elkins Park, PA (US)

(21) Appl. No.: 15/162,819

(22) Filed: May 24, 2016

Related U.S. Application Data
(60) Provisional application No. 62/167,862, filed on May 28, 2015.

(51) Int. Cl. G06Q 40/00; G06Q 50/26

(52) U.S. Cl. CPC G06Q 40/00; G06Q 50/26

(57) ABSTRACT

A system and method for calculating an economic benefit that accrues from the performance of one or more social services. The system and method includes performing one or more social services and inputting values derived from the performance of those services into a computing environment. The computing environment uses the inputted values, in addition to data taken from one or more databases containing social service data, to calculate the economic benefit accrued through the performance of the one or more social services. The economic benefit values can be stored in one or more data repositories, or can be directly viewed by a user through a web-based portal.

### RELATED APPLICATIONS

This application claims the benefit of U.S. Provisional Application No. 62/167,862, filed May 28, 2015, which is hereby incorporated herein in its entirety.

### BACKGROUND

Nonprofit organizations and social service programs benefit society by offering services at no or reduced cost to individual and community beneficiaries, as compared to profit-driven organizations. Exemplary services offered by nonprofit organizations and social service programs include legal service, human service, or government service. Often, the economic benefit to society as a whole from these services is greater than the total cost of providing the services themselves. These economic values can be difficult to calculate, though it may be desirable to determine the monetary economic value of such services for various reasons, including publicizing the impact of the nonprofit organization or social service, requesting funding, and planning for future service offerings. A need exists for an accurate tool for calculating the economic benefits of nonprofit and social services organizations, especially a tool that offers an easy-to-use method that can be directly accessed by the organizations themselves.

### SUMMARY OF THE EMBODIMENTS

Embodiments can provide a method of calculating an economic benefit resulting from a social service using a computer program, which can comprise performing one or more social services; loading the computer program, wherein the computer program can provide at least one inquiry concerning the social service; responding to the at least one inquiry; and calculating the economic benefit using the computer program.

Embodiments can further provide a method wherein the one or more social services can comprise one or more of a legal service, human service, or government service. Embodiments can further provide a method which can comprise accessing the computer program through a web-based portal. Embodiments can further provide a method wherein the at least one inquiry can comprise a series of inquiries. Embodiments can further provide a method which can comprise loading one or more values into the computer program taken from one or more databases. Embodiments can further provide a method which can comprise outputting the economic benefit to a user through a graphical user interface. Embodiments can further provide a method which can comprise storing the calculated economic benefit in one or more data repositories.

Embodiments can provide a computer implemented method in a computing environment comprising a processor and a memory containing instructions, which can be executed by the processor to cause the processor to implement an economic benefits calculator system, where the method can comprise performing, by one or more individuals or organizations, one or more social services; inputting, through a user interface, one or more variables associated with the performance of the one or more social services; calculating, through the processor, the economic benefit created by the performance of the one or more social services. Embodiments can further provide a method which can comprise receiving, from one or more databases, historical data related to the one or more social services. Embodiments can further provide a method which can comprise accessing, through a web-based portal, the economic benefits calculator. Embodiments can further provide a method which can comprise outputting, through a graphical user interface in connection with the processor, the calculated economic benefit to a user. Embodiments can further provide a method which can comprise storing, through one or more data repositories connected to the processor, the calculated economic benefit. Embodiments can further provide a method wherein calculating the economic benefit can be accomplished through application of one or more algorithms specific to social service work. Embodiments can further provide a method wherein the one or more social services can be one or more of a legal service, human service, or government service.

Embodiments can provide a system for calculating an economic benefit accrued through the performance of one or more social services by one or more individuals or organizations, which can comprise a processor configured to provide one or more inquiries related to the performance of the one or more social services and; calculate, using one or more answers provided to the one or more inquiries, one or more values reflecting the economic benefit accrued through the performance of the one or more social services.

Embodiments can further provide a system which can comprise a web-based portal connected to the processor; wherein the web-based portal can be configured to receive the one or more answers provided by the user and output the economic benefit calculated by the processor. Embodiments can further provide a system which can comprise one or more databases containing social service data; wherein the social service data can be used by the processor to calculate the economic benefit. Embodiments can further provide a system which can comprise one or more data repositories; wherein the processor is further configured to output the one or more values of economic benefit to the one or more data repositories. Embodiments can further provide a system wherein the one or more social services can comprise one or more of a legal service, human service, or government service. Embodiments can further provide a system wherein the one or more answers can be derived from one or more documents uploaded to the system by a user.

### BRIEF DESCRIPTION OF THE DRAWINGS

FIG. 1 is a flow chart illustrating a method for calculating an economic benefit, according to an embodiment described herein;

FIG. 2 illustrates an example of a first inquiry that may be presented according to the method of FIG. 1;

FIG. 3 illustrates an example of a second inquiry that may be presented according to the method of FIG. 1;

FIG. 4 illustrates an example of a third inquiry that may be presented according to the method of FIG. 1;

FIG. 5 illustrates an example of a fourth inquiry that may be presented according to the method of FIG. 1;

FIG. 6 illustrates an example of an economic benefit value that may be calculated according to the method of FIG. 1; and

FIG. 7 illustrates an example of a computing environment within which embodiments of the invention may be implemented.

### DETAILED DESCRIPTION OF EMBODIMENTS

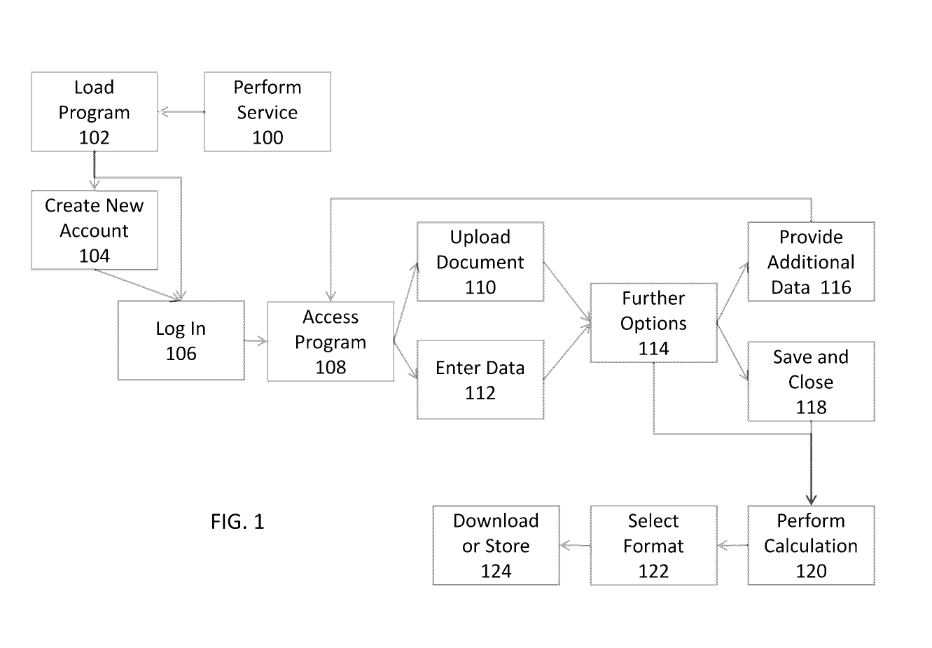

FIG. 1 illustrates a process of performing an economic benefit calculation. As shown, the method includes a step of one or more individuals or organizations performing a social service 100 resulting in a successful outcome. The terms “social service” and “social program” may be used interchangeably herein and are each defined as a service or activity performed for an individual or a group, optionally at no cost or a reduced cost to the individual or group, with an aim towards the benefit of a community. Such services and programs may include, but not be limited to, human services, legal services, government services, or a combination thereof. Optionally, in step 100, multiple social services may be performed, and the economic benefit of the services as a whole may be calculated and aggregated according to the method described herein.

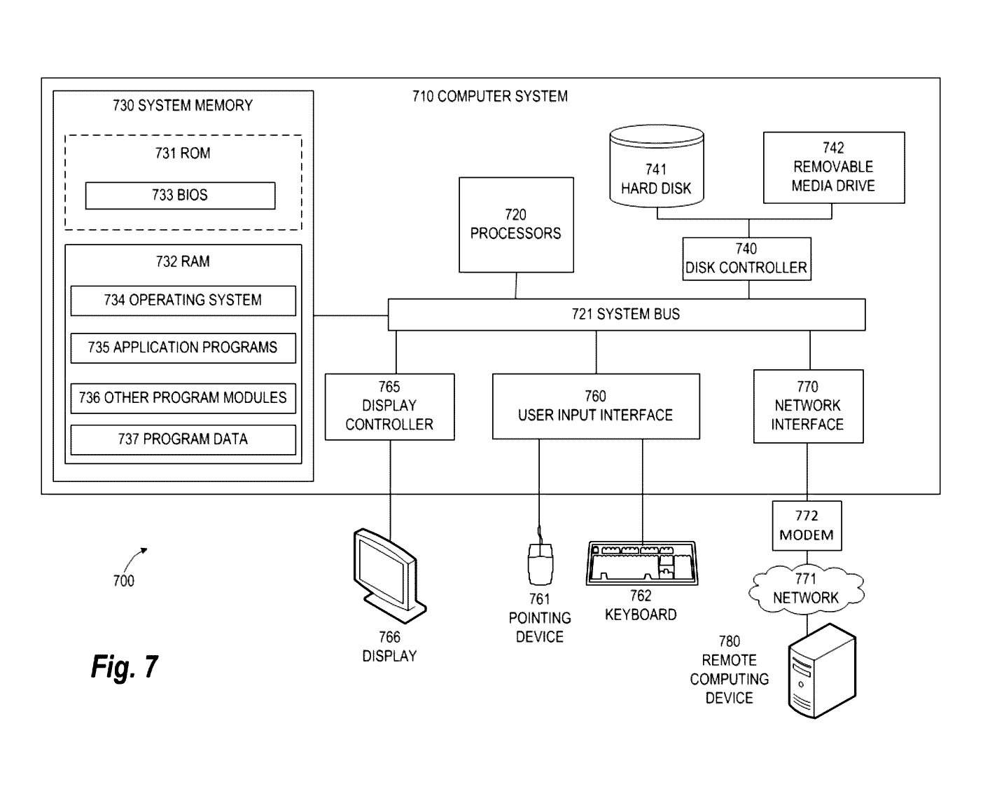

Following performance of one or more social services in step 100, a user can load a computer program configured to perform the economic benefit calculation in step 102. The computer program may be a web program loaded by loading a web page. In another embodiment, the program can be stored within a computer and loaded by simply opening the program. In another embodiment, the method can be stored on a computer system as described in FIG. 7. Upon loading the program in step 102, a user can be given a first option of creating a new account in step 104 or a second option of logging in using an existing account in step 106. If the user is a first time user of the computer program, he can select the first option in step 104 and create a new account, which may require creation of new credentials, such as a username and password. The user may then login in step 106, using the newly created credentials. If the user has previously used the computer program, he will have previously created credentials according to step 104, and may now bypass this step and proceed directly to step 106 by logging in using the credentials.

After logging in in step 106, the user may access the program in step 108. Upon accessing the program in step 108, the user is prompted to provide data from which an economic benefit calculation will be performed. The user may be given a first option of uploading a document containing the data in step 110, and a second option of entering the data manually in step 112. If the user selects the first option in step 110, a document, which may be, for example, a spreadsheet, containing the data is uploaded. In some embodiments, a spreadsheet template containing the required fields may be provided for the user to complete and upload. In another embodiment, the user may create a document containing the data from a blank spreadsheet, and the program configured to interpret the data. If the user selects the second option in step 112, the data may be entered manually. For example, the program may provide the user with a series of prompts or inquiries that the user responds to in order to provide the data.

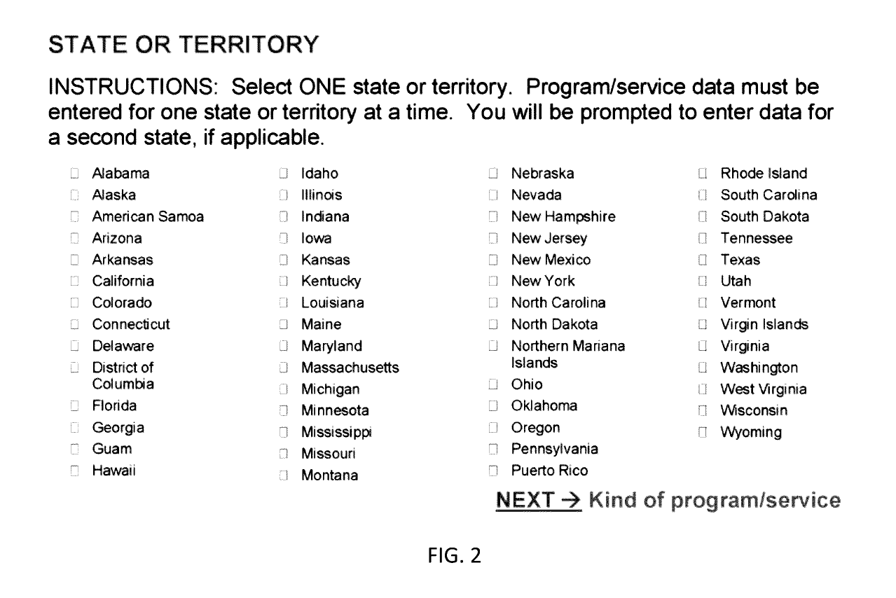

FIG. 2 illustrates an example of a first inquiry that may be presented. As shown, the user can be requested to select one state or territory in which the social service was provided. In the embodiment shown, the user can be requested to select a single state or territory, but may subsequently be requested to select additional states or territories. In another embodiment, the user may be requested to select all states or territories in which the service was provided in response to a single request. In another embodiment, the user may be requested to select from one or more countries, counties, cities, or other geographic regions.

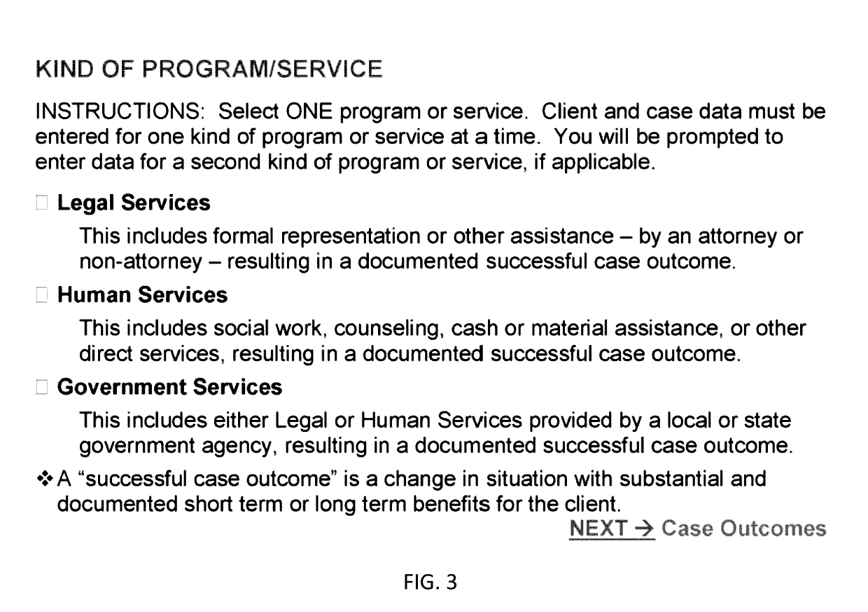

FIG. 3 illustrates an example of a second inquiry that may be presented. As shown, the user can be requested to select the program or service performed in step 100. In the embodiment shown, the user can be requested to select a single program or service, but may be subsequently permitted to select additional programs or services. In another embodiment, the user may be requested to select all programs or services in response to a single request. In the illustrated embodiment, the user can be given the option of selecting among legal service, human service, or government service. In other embodiments, other or different types of services may be provided as options. In the illustrated embodiment, the user can be instructed to select only services resulting in successful outcomes. In other embodiments, the user may be permitted to select among services having partially successful or unsuccessful outcomes, which may, for example, be taken into account as a partial economic benefit or an economic detriment, respectively.

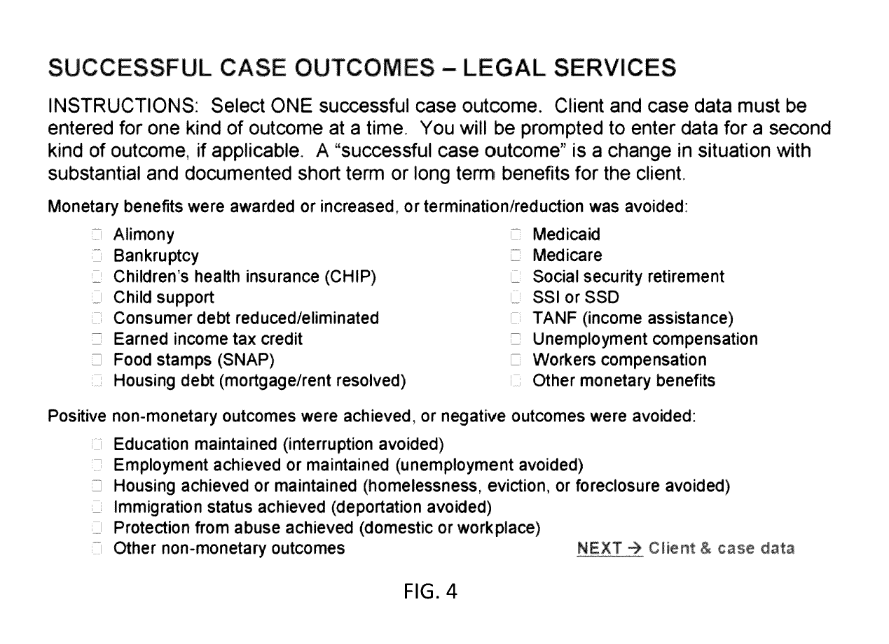

FIG. 4 illustrates an example of a third inquiry that may be presented. As shown, the user can be requested to select a successful case outcome. In the example shown, the successful case outcomes provided can be of the type that may be achieved in connection with legal services, and such a request can be provided following the user selecting “legal services,” in response to the inquiry shown in FIG. 3. Had the user selected another type of services, the outcomes presented in FIG. 4 could correspond to expected successful outcomes in connection with the type of services selected. As shown, the options presented as successful outcomes can be divided between those in which monetary benefits were awarded or increased or termination/reduction was avoided, and those in which positive non-monetary outcomes were achieved or negative outcomes were avoided. In another embodiment, all potential outcomes could be presented together. In the embodiment shown, the user can be requested to select only a single successful outcome, but may be subsequently requested to select additional successful outcomes. In another embodiment, the user may be requested to select all successful outcomes in response to a single request.

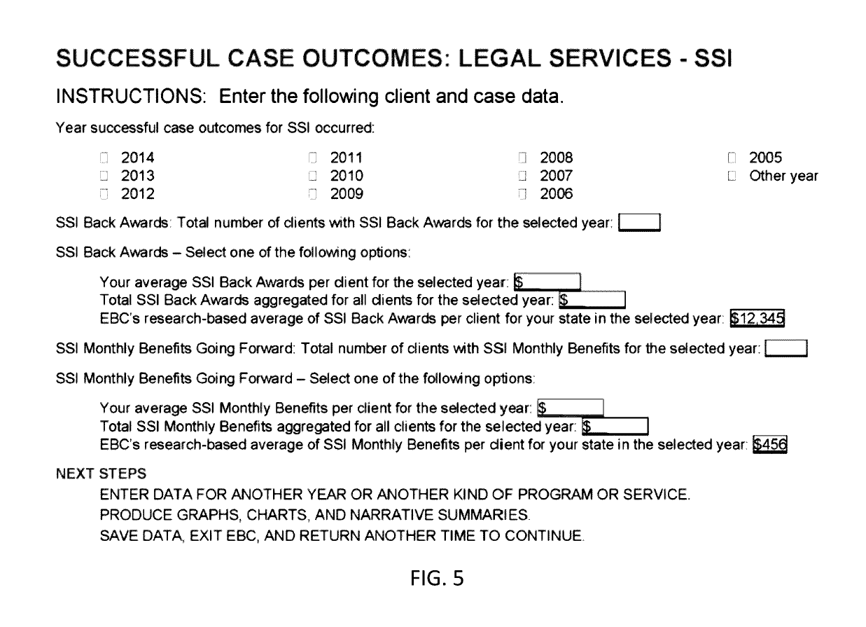

FIG. 5 illustrates an example of a fourth inquiry that may be presented. As shown, the user can be requested to provide additional details concerning the successful outcome selected in the inquiry shown in FIG. 4. In the example shown, the additional details requested are of the type associated with the successful outcome of an award of Supplemental Security Income (“S SI”), and such a request could be provided following the user selecting an award of SSI in the inquiry of FIG. 4. Had the user selected a different successful outcome, a different set of requests could be provided in FIG. 5, corresponding to details typically associated with that type of successful outcome.

While FIGS. 2-5 illustrate a set of inquiries in accordance with some embodiments, the program and method of this application should not be viewed as limited to these specific inquiries. Fewer, more, or a different set of inquiries may be provided, depending on the type of service or program and the type and accuracy of the economic benefit calculation performed.

In step 114, after uploading the data in step 110 or entering it manually in response to inquiries in step 112, the user may be presented with further options. As shown, the user may, in step 116, opt to repeat step 110 or 112 by providing data for another program or service. Alternatively, the user may opt to save the data and close the program in step 118, permitting the user to recommence the steps in performing the calculation at a later time. Alternatively, the user may proceed directly to step 120, to perform the calculation.

In step 120, the computer program can perform the calculation. The calculation translates the data entered in steps 110 or 112, into an economic benefit. The user may, in step 122, select a format in which the economic benefit is presented. For example, the economic benefit may be presented as a simple monetary value. Where a simple monetary value is insufficient to convey the economic benefit, the economic benefit may be presented in another format, such as a graph, chart or narrative summary.

The computer program can be configured to perform the calculation by comparing the social program or social service and outcomes with historical data about the economic benefits of similar past social services or social programs. In some embodiments, data on social programs and social services may be collected over time and input into a database to create an algorithm for performing economic benefit calculations. For example, data concerning social programs and social services may be gathered and subjected to inquiries similar to those presented to the user in order to perform the economic benefit calculation, with the responses entered into a database. Additional information concerning the known economic benefits of the past social services or social programs may be gathered and entered into the database. In some embodiments, the database may be updated periodically by adding data concerning more recent social programs and social services, as well as by removing outdated data concerning older social programs and social services, so as to ensure the economic benefit calculation is performed based on current data. In some embodiments, the details associated with these databases, calculations and algorithms can correspond to the nature of the social programs and social services, including the geographic location where the services were provided, the historical impact of similar services, and other factors.

The method and system described can use government (and other entity)-produced data and multipliers with other research-based data in an algorithm into which the nonprofit and social service organization data can also be entered to produce the resulting economic benefit calculations and corresponding graphic and narrative presentations described. The method and system described can involve multiple algorithms, with separate and distinctive formulas applied for each corresponding social service and social program, often with interactions between the various algorithms. The utility and accuracy of the method and system depend on research, analysis, and design exclusively performed and periodically updated by the applicant to determine the variables and structure of the various algorithms, the data needed for their operation, and the most efficacious computer program design for user inquiries and interaction to generate economic benefit calculations and corresponding graphic and narrative presentations. Of equal importance, the simplicity and ease-of-use of the method and system also depend on research, analysis, and design exclusively performed and periodically updated by the applicant to ensure users in nonprofit and social service organizations without any technical knowledge of these methods and systems can directly access this tool and generate on a self-service basis the economic benefit calculations and corresponding graphic and narrative presentations.

Generally, the algorithms can have limited complexity, with a few variables needing input from a user, and several other variables with values derived from pre-loaded data sets, such as publically available government data sets. Examples of potential algorithms that can be implemented by the system described herein can be as follows:

The economic impact of preventing homelessness can be calculated by multiplying the number of cases for which eviction or foreclosure was avoided or delayed by the percentage of those cases for which homelessness was avoided. The resulting number can be further multiplied by the average cost to the taxpayers per homeless family, which can result in a measure of the economic impact for that particular service.

The economic impact of families receiving child care can be calculated by subtracting the ratio of a teacher's salary to the number of children enrolled in that teacher's class from the income earned by a parent due to the ability to work by having access to child care. Further subtracted from that result can be the value of child care and other tasks formerly provided by the parent prior to working. The resulting number can be multiplied by the number of families for which early childhood education was provided, which can result in a measure of the impact for that particular service.

The economic impact of audiences attending arts events can be calculated by multiplying the total audience members attending an event by the average expenditure per audience member in business surrounding the venue for an average event, such as expenditures at restaurants or bars and for parking. This result can have added the total audience expenditures at the arts event venue, including but not limited to ticket sales, refreshments, and gift shop purchases. This resulting number can be multiplied by a pre-determined economic impact multiplier to calculate the economic impact for the arts event or events.

The economic impact of providing access to food stamps can be calculated by multiplying the number of people who have been assisted to receive food stamps by the average food stamp benefits received per eligible person, which can then be multiplied by an economic impact multiplier derived from available research.

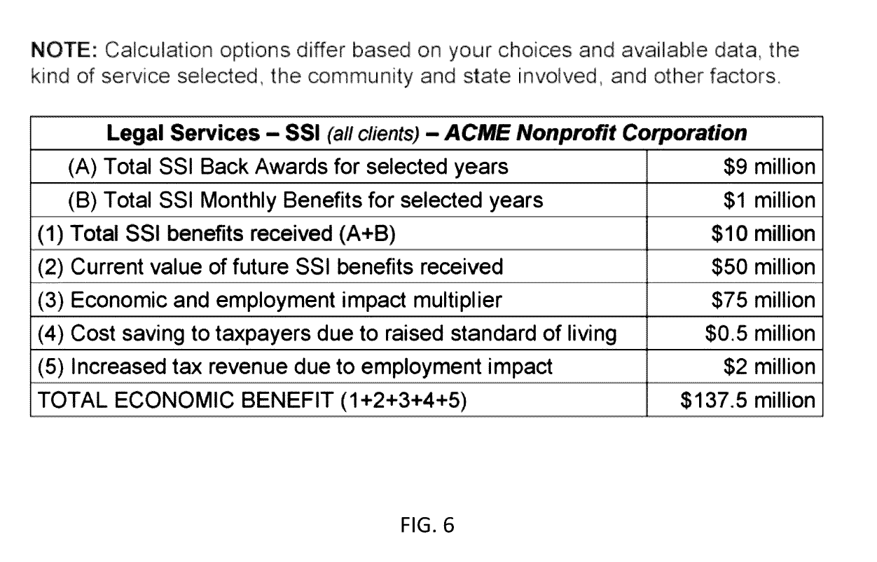

FIG. 6 shows one example of a format in which an economic benefit may be presented. In the example shown, the economic benefit can be associated with the successful outcome of an award of supplemental security income (S SI). Had the user entered data associated with a different type of service or program, the economic benefit would be of a type associated with such a service or program. FIG. 6 shows an economic benefit presented in the form of a chart. The chart includes a left hand column listing the quantifiable components of the economic benefit, and a right hand column listing the monetary value of each component. A sum of the monetary values, equal to the total economic benefit, can be provided at the bottom of the right hand column.

In step 124, the user is given the option of downloading the economic benefit, storing the economic benefit in a content repository, or both. The economic benefit may be downloaded or stored in the format selected in step 122. In embodiments in which the computer program is accessed via a web page, the economic benefit may be stored on the website through which the computer program is accessed. In some embodiments, the economic benefit may be stored on the website for a fee. (Fees may be charged for other services within the embodiments as well.)

FIG. 7 illustrates an example of a computing environment 700 within which embodiments of the invention may be implemented. Computing environment 700 may be implemented as part of any component described herein. Computing environment 700 may include computer system 710, which is one example of a computing system upon which embodiments of the invention may be implemented. As shown in FIG. 7, the computer system 710 may include a communication mechanism such as a bus 721 or other communication mechanism for communicating information within the computer system 710. The system 710 further includes one or more processors 720 coupled with the bus 721 for processing the information. The processors 720 may include one or more CPUs, GPUs, or any other processor known in the art.

The computer system 710 also includes a system memory 730 coupled to the bus 721 for storing information and instructions to be executed by processors 720. The system memory 730 may include computer readable storage media in the form of volatile and/or nonvolatile memory, such as read only memory (ROM) 731 and/or random access memory (RAM) 732. The system memory RAM 732 may include other dynamic storage device(s) (e.g., dynamic RAM, static RAM, and synchronous DRAM). The system memory ROM 731 may include other static storage device(s) (e.g., programmable ROM, erasable PROM, and electrically erasable PROM). In addition, the system memory 730 may be used for storing temporary variables or other intermediate information during the execution of instructions by the processors 720. A basic input/output system (BIOS) 733 containing the basic routines that help to transfer information between elements within computer system 710, such as during start-up, may be stored in ROM 731. RAM 732 may contain data and/or program modules that are immediately accessible to and/or presently being operated on by the processors 720. System memory 730 may additionally include, for example, operating system 734, application programs 735, other program modules 736, and program data 737.

The computer system 710 also includes a disk controller 740 coupled to the bus 721 to control one or more storage devices for storing information and instructions, such as a magnetic hard disk 741 and a removable media drive 742 (e.g., floppy disk drive, compact disc drive, tape drive, and/or solid state drive). The storage devices may be added to the computer system 710 using an appropriate device interface (e.g., a small computer system interface (SCSI), integrated device electronics (IDE), Universal Serial Bus (USB), or FireWire).

The computer system 710 may also include a display controller 765 coupled to the bus 721 to control a display or monitor 766, such as a cathode ray tube (CRT) or liquid crystal display (LCD), for displaying information to a computer user. The computer system 710 includes a user input interface 760 and one or more input devices, such as a keyboard 762 and a pointing device 761, for interacting with a computer user and providing information to the processor 720. The pointing device 761, for example, may be a mouse, a trackball, or a pointing stick for communicating direction information and command selections to the processor 720 and for controlling cursor movement on the display 766. The display 766 may provide a touch screen interface which allows input to supplement or replace the communication of direction information and command selections by the pointing device 761.

The computer system 710 may perform a portion or all of the processing steps of embodiments of the invention in response to the processors 720 executing one or more sequences of one or more instructions contained in a memory, such as the system memory 730. Such instructions may be read into the system memory 730 from another computer readable medium, such as a hard disk 741 or a removable media drive 742. The hard disk 741 may contain one or more data stores and data files used by embodiments of the present invention. Data store contents and data files may be encrypted to improve security. The processors 720 may also be employed in a multi-processing arrangement to execute the one or more sequences of instructions contained in system memory 730. In alternative embodiments, hard-wired circuitry may be used in place of or in combination with software instructions. Thus, embodiments are not limited to any specific combination of hardware circuitry and software.

As stated above, the computer system 710 may include at least one computer readable medium or memory for holding instructions programmed according to embodiments of the invention and for containing data structures, tables, records, or other data described herein. The term “computer readable medium” as used herein refers to any non-transitory, tangible medium that participates in providing instructions to the processor 720 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 741 or removable media drive 742. Non-limiting examples of volatile media include dynamic memory, such as system memory 730. Non-limiting examples of transmission media include coaxial cables, copper wire, and fiber optics, including the wires that make up the bus 721. Transmission media may also take the form of acoustic or light waves, such as those generated during radio wave and infrared data communications.

The computing environment 700 may further include the computer system 710 operating in a networked environment using logical connections to one or more remote computers, such as remote computer 780. Remote computer 780 may be a personal computer (laptop or desktop), a mobile device, a server, a router, a network PC, a peer device, or other common network node, and typically includes many or all of the elements described above relative to computer 710. When used in a networking environment, computer 710 may include modem 772 for establishing communications over a network 771, such as the Internet. Modem 772 may be connected to system bus 721 via network interface 770, or via another appropriate mechanism.

Network 771 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 710 and other computers (e.g., remote computing system 780). The network 771 may be wired, wireless, or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite, or any other wireless connection methodology generally known in the art. Additionally, several networks may work alone or in communication with each other to facilitate communication in the network 771.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting, or transmitting information for use by an executable procedure or an information device, and/or by routing the information to an output device. A processor may use or comprise the capabilities of a computer, controller, or microprocessor, for example, and is conditioned using executable instructions to perform special purpose functions not performed by a general purpose computer. A processor may be coupled (electrically and/or as comprising executable components) with any other processor enabling interaction and/or communication there-between. Computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s). A user interface processor or generator is a known element comprising electronic circuitry or software or a combination of both for generating display elements or portions thereof. A user interface (UI) comprises one or more display elements enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display elements, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the elements for viewing by the user. The executable procedure or executable application further receives signals from user input devices, such as a keyboard, mouse, light pen, touch screen, or any other means allowing a user to provide data to a processor. The processor, under control of an executable procedure or executable application, manipulates the UI display elements in response to signals received from the input devices. In this way, the user interacts with the display elements using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

A workflow processor, as used herein, processes data to determine tasks to add to, or remove from, a task list or modifies tasks incorporated on, or for incorporation on, a task list, as for example specified in a program(s). A task list is a list of tasks for performance by a worker, user of a device, or device or a combination of both. A workflow processor may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision, and task allocation steps for performance by a device and or worker, for example. An event is an occurrence affecting operation of a process implemented using a process definition. The workflow engine includes a process definition function that allows users to define a process that is to be followed and may include an Event Monitor.

The system and processes of the figures presented herein are not exclusive. Other systems, processes, and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, the processes and applications may, in alternative embodiments, be located on one or more (e.g., distributed) processing devices on a network linking the units of FIG. 7. Any of the functions and steps provided in the Figures may be implemented in hardware, software, or a combination of both. No claim element herein is to be construed under the provisions of 35 U.S.C. 112, sixth paragraph, unless the element is expressly recited using the phrase “means for.”

While the invention has been described with reference to the embodiments above, a person of ordinary skill in the art would understand that various changes or modifications may be made thereto without departing from the scope of the claims.

1. A method of calculating an economic benefit resulting from a social service using a computer program, comprising:
performing one or more social services;
loading the computer program, wherein the computer program provides at least one inquiry concerning the social service;
responding to the at least one inquiry; and
calculating the economic benefit using the computer program.

2. The method of claim 1, wherein the one or more social services comprise one or more of a legal service, human service, or government service.

3. The method of claim 1, further comprising:
accessing the computer program through a web-based portal.

4. The method of claim 1, wherein the at least one inquiry comprises a series of inquiries.

5. The method of claim 1, further comprising:
loading one or more values into the computer program taken from one or more databases.

6. The method of claim 1, further comprising:
outputting the economic benefit to a user through a graphical user interface.

7. The method of claim 1, further comprising:
storing the calculated economic benefit in one or more data repositories.

8. A computer implemented method in a computing environment comprising a processor and a memory containing instructions, which are executed by the processor to cause the processor to implement an economic benefits calculator system, the method comprising:
performing, by one or more individuals or organizations, one or more social services;
inputting, through a user interface, one or more variables associated with the performance of the one or more social services;
calculating, through the processor, the economic benefit created by the performance of the one or more social services.

9. The method as recited in claim 8, further comprising:
receiving, from one or more databases, historical data related to the one or more social services.

10. The method as recited in claim 8, further comprising:
accessing, through a web-based portal, the economic benefits calculator.

11. The method as recited in claim 8, further comprising:
outputting, through a graphical user interface in connection with the processor, the calculated economic benefit to a user.

12. The method as recited in claim 8, further comprising:
storing, through one or more data repositories connected to the processor, the calculated economic benefit.

13. The method as recited in claim 8, wherein calculating the economic benefit is accomplished through application of one or more algorithms specific to social service work.

14. The method of claim 8, wherein the one or more social services is one or more of a legal service, human service, or government service.

15. A system for calculating an economic benefit accrued through the performance of one or more social services by one or more individuals or organizations, the system comprising:
a processor configured to:
provide one or more inquiries related to the performance of the one or more social services; and
calculate, using one or more answers provided to the one or more inquiries, one or more values reflecting the economic benefit accrued through the performance of the one or more social services.

16. The system as recited in claim 15, further comprising:
a web-based portal connected to the processor;
wherein the web-based portal is configured to receive the one or more answers provided by a user and output the economic benefit calculated by the processor.

17. The system as recited in claim 15, further comprising:
one or more databases containing social service data;
wherein the social service data is used by the processor to calculate the economic benefit.

18. The system as recited in claim 15, further comprising:
one or more data repositories;
wherein the processor is further configured to output the one or more values of economic benefit to the one or more data repositories.

19. The system as recited in claim 15, wherein the one or more social services is one or more of a legal service, human service, or government service.

20. The system as recited in claim 15, wherein the one or more answers are derived from one or more documents uploaded to the system by a user.
